(19) United States
(12) Patent Application Publication
(10) Pub. No.: US 2020/0327354 A1
(43) Pub. Date: Oct. 15, 2020

(54) System and method for object recognition

(71) Applicant: Fingram Co., Ltd., Yongin-si (KR)

(72) Inventors: Young Cheul Wee, Suwon-si (KR); Young Hoon Ahn, Suwon-si (KR); Yang Seong Jin, Suwon-si (KR)

(21) Appl. No.: 16/800,472

(22) Filed: Feb. 25, 2020

(30) Foreign Application Priority Data
Feb. 26, 2019 (KR) 10-2019-0022777

(51) Int. Cl. G06K 9/46; G06T 5/50; G06K 9/62; G06N 3/08

(52) U.S. Cl. CPC G06K 9/4628; G06T 5/50; G06K 9/6217; G06K 2209/01; G06T 2207/20221; G06T 2207/20084; G06N 3/08

(57) ABSTRACT

An object recognition system and a method thereof are disclosed. The object recognition system includes: a preprocessing module for generating a first image, in which features of an object displayed in an original image to be recognized are enhanced in a first method on the basis of the original image, and a second image generated on the basis of the original image, in which the features of the object are enhanced in a second method; and a neural network module trained to receive the first image and the second image generated by the preprocessing module and output a result of recognizing the object.

### TECHNICAL FIELD

The present invention relates to an object recognition system and a method thereof, and more specifically, to an object recognition system and a method thereof, which can recognize an object (e.g., a character, a numeral, a symbol or the like) displayed in an image more effectively using a neural network.

### BACKGROUND ART

The need for object recognition is growing in various fields.

A representative example is the optical character recognition (OCR) field, and recently, a deep learning method using a neural network is widely used even in the OCR field.

Particularly, a method which allows a neural network (e.g., a deep learning method using a convolution neural network (CNN)), which is a kind of machine learning, to extract features of an object (e.g., a character) through learning and provides a high recognition rate using the features, although a user does not detect the features of the object one by one using the neural network, is widely studied.

In the object recognition through a neural network, it is known that the neural network may have higher recognition performance when a predetermined preprocessing process is conducted for the neural network to learn the features well.

In the preprocessing process like this, it is desirable to enhance the features of an object to be robust to noise such as lighting, background or the like.

Although it is widely known that the preprocessing like this uses various filters and/or binarization techniques, such techniques alone may not sufficiently enhance the features of the object.

Accordingly, a method capable of enhancing object recognition performance by more effectively enhancing the features of an object is required.

### DOCUMENT OF PRIOR ART

(Patent Document 1) Korean Laid-Open Patent No. 10-2015-0099116 “Color character recognition method and device using OCR”

### DISCLOSURE OF INVENTION

### Technical Problem to be Solved

Therefore, the present invention has been made in view of the above problems, and it is an object of the present invention to provide a method and a system for enhancing object recognition performance by generating a plurality of input information that can enhance features of an object and utilizing the generated input information for object recognition.

### Technical Solution

To accomplish the above object, according to one aspect of the present invention, there is provided an object recognition system comprising: a preprocessing module for generating a first image, in which features of an object displayed in an original image to be recognized are enhanced in a first method on the basis of the original image, and a second image generated on the basis of the original image, in which the features of the object are enhanced in a second method; and a neural network module trained to receive the first image and the second image generated by the preprocessing module and output a result of recognizing the object.

The first image may be an image having a difference value between a predetermined pixel based on the original image and an adjacent pixel in a first direction of the pixel as a pixel value, and the second image may be an image having a difference value between a predetermined pixel based on the original image and an adjacent pixel in a second direction of the pixel as a pixel value.

The first direction is an x-axis direction, and the second direction is a y-axis direction.

The preprocessing module generates an input image by stitching the first image and the second image in a predetermined direction, and the neural network module receives the input image.

An object recognition system according to another embodiment includes: a preprocessing module for generating a first image generated from an original image to be recognized and having a difference value of an adjacent pixel in an x-axis direction as a pixel value, and a second image generated from the original image and having a difference value of an adjacent pixel in a y-axis direction as a pixel value, and generating an input image by stitching the generated first image and second image; and a neural network module trained to receive the input image generated by the preprocessing module and output a result of recognizing the object displayed in the original image.

An object recognition method according to the spirit of the present invention includes the steps of: generating a first image, in which features of an object displayed in an original image to be recognized are enhanced in a first method on the basis of the original image, and a second image generated on the basis of the original image, in which the features of the object are enhanced in a second method, by an recognition system; and receiving the generated first image and second image and outputting a result of recognizing the object, by a neural network included in the recognition system.

The first image is an image having a difference value between a predetermined pixel based on the original image and an adjacent pixel in a first direction of the pixel as a pixel value, and the second image is an image having a difference value between a predetermined pixel based on the original image and an adjacent pixel in a second direction of the pixel as a pixel value.

The object recognition method further includes the step of generating an input image by stitching the first image and the second image in a predetermined direction, wherein the step of receiving the generated first image and second image and outputting a result of recognizing the object by a neural network included in the recognition system receives the input image.

An object recognition method according to another embodiment includes the steps of: generating a first image, in which features of an object displayed in an original image to be recognized are enhanced in a first method on the basis of the original image, by an recognition system; and generating a second image generated on the basis of the original image, in which the features of the object are enhanced in a second method, by the recognition system, wherein a result of recognizing the object is outputted through a predetermined neural network on the basis of the generated first image and second image.

The method described above may be implemented through a computer program installed in a data processing apparatus and hardware of the data processing apparatus capable of executing the computer program.

### Advantageous Effects

According to the spirit of the present invention, there is an effect of providing high recognition performance through more enhanced object features by generating a plurality of input information in which features of an object to be recognized are enhanced from an original image displaying the object, and training a neural network for object recognition to learn all of the plurality of generated input information.

### BRIEF DESCRIPTION OF THE DRAWINGS

To more sufficiently understand the drawings cited in the detailed description of the present invention, a brief description of each drawing is provided.

FIG. 1 is a view showing the logical configuration of an object recognition system according to the spirit of the present invention.

FIG. 2 is a view showing the hardware system configuration of an object recognition system according to an embodiment of the present invention.

FIG. 3 is a view showing the process of an object recognition method according to an embodiment of the present invention.

FIG. 4 is a view showing an example of an original image and an input image used in an object recognition method according to an embodiment of the present invention.

### BEST MODE FOR CARRYING OUT THE INVENTION

Since the present invention may be diversely modified and have various embodiments, specific embodiments will be shown in the drawings and described in detail in the detailed description. However, it should be understood that this is not intended to limit the present invention to the specific embodiments, but to comprise all modifications, equivalents and substitutions included in the spirit and scope of the present invention. In describing the present invention, if it is determined that the detailed description on the related known art may obscure the gist of the present invention, the detailed description will be omitted.

The terms such as “first” and “second” may be used in describing various constitutional components, but the above constitutional components should not be restricted by the above terms. The above terms are used only to distinguish one constitutional component from the other.

The terms used herein are used only to describe particular embodiments and are not intended to limit the present invention. A singular expression includes a plural expressions, unless the context clearly indicates otherwise.

It should be understood that in this specification, the terms “include” and “have” specify the presence of stated features, numerals, steps, operations, constitutional components, parts, or a combination thereof, but do not preclude in advance the possibility of presence or addition of one or more other features, numerals, steps, operations, constitutional components, parts, or a combination thereof.

In addition, in this specification, when any one of constitutional components “transmits” a data to another constitutional component, it means that the constitutional component may directly transmits the data to another constitutional component or may transmit the data to another constitutional component through at least one of the other constitutional components. On the contrary, when any one of the constitutional components “directly transmits” a data to another constitutional component, it means that the data is transmitted to another constitutional component without passing through the other constitutional components.

Hereinafter, the present invention is described in detail focusing on the embodiments of the present invention with reference to the attached drawings. Like reference symbols presented in each drawing denote like members.

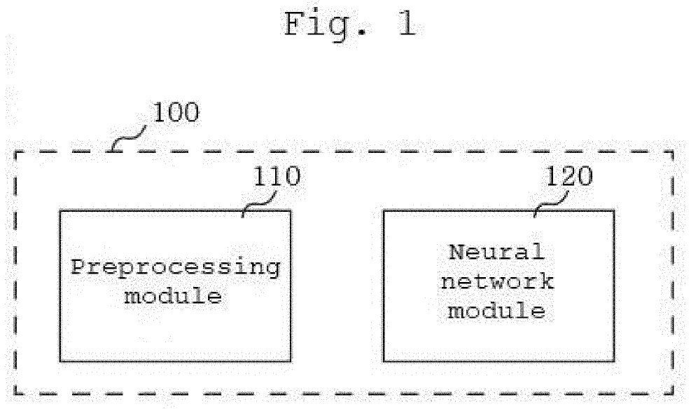

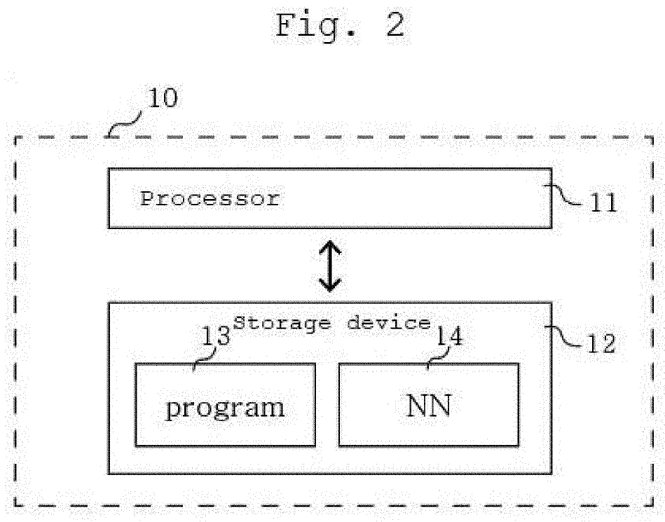

FIG. 1 is a view showing the logical configuration of an object recognition system according to the spirit of the present invention. In addition, FIG. 2 is a view showing the hardware system configuration of an object recognition system according to an embodiment of the present invention.

Referring to FIG. 1, an object recognition system 100 may be implemented to implement an object recognition method according to the spirit of the present invention. The object recognition system (hereinafter, a recognition system 100) may be installed in a predetermined data processing system 10 to implement the spirit of the present invention.

The data processing system 10 means a system having a computing capability for implementing the spirit of the present invention, and average experts in the technical field of the present invention may easily infer that any system capable of performing a service using object recognition according to the spirit of the present invention, such as a personal computer, a portable terminal, or the like, as well as a network server generally accessible by a client through a network, may be defined as the data processing system 10 defined in this specification.

Hereinafter, although a case in which an object to be recognized is a character is described as an example in this specification, average experts in the technical field of the present invention may easily infer that the technical spirit of the present invention can be applied in various fields in addition to the character.

The data processing system 10 may include a processor 11 and a storage device 12 as shown in FIG. 2. The processor 11 may mean a computing device capable of driving a program 13 for implementing the spirit of the present invention, and the processor 11 may perform object recognition using the program 13 and a neural network 14 defined by the spirit of the present invention.

The storage device 12 may means a data storage means capable of storing the program 13 and the neural network 14, and may be implemented as a plurality of storage means according to embodiments. In addition, the storage device 12 may mean not only a main memory device included in the data processing system 10, but also a temporary storage device or a memory that can be included in the processor 11.

Although it is shown in FIG. 1 or 2 that the recognition system 100 is implemented as any one physical device, average experts in the technical field of the present invention may easily infer that a plurality of physical devices may be systematically combined as needed to implement the recognition system 100 according to the spirit of the present invention.

According to the spirit of the present invention, the recognition system 100 may include a preprocessing module 110 for generating predetermined input information from an original image, and a neural network module 120 for receiving the input information generated by the preprocessing module 110 and outputting a recognition result.

The recognition system 100 may means a logical configuration having hardware resources and/or software needed for implementing the spirit of the present invention, and does not necessarily means a physical component or a device. That is, the recognition system 100 may mean a logical combination of hardware and/or software provided to implement the spirit of the present invention, and if necessary, the recognition system 100 may be installed in devices spaced apart from each other and perform respective functions to be implemented as a set of logical configurations for implementing the spirit of the present invention. In addition, the recognition system 100 may mean a set of components separately implemented as each function or role for implementing the spirit of the present invention. For example, each of the preprocessing module 110 and/or the neural network module 120 may be located in different physical devices or in the same physical device. In addition, according to embodiments, combinations of software and/or hardware configuring each of the preprocessing module 110 and/or the neural network module 120 may also be located in different physical devices, and components located in different physical devices may be systematically combined with each other to implement each of the above modules.

In addition, a module in this specification may mean a functional and structural combination of hardware for performing the spirit of the present invention and software for driving the hardware. For example, average experts in the technical field of the present invention may easily infer that the module may mean a logical unit of a predetermined code and hardware resources for performing the predetermined code, and does not necessarily mean a physically connected code or a kind of hardware.

The recognition system 100 may construct the neural network module 120 by training a neural network to implement the spirit of the present invention. The constructed neural network module 120 may output a recognition result on the basis of input information inputted from the preprocessing module 110.

According to an example, the neural network may be a CNN, but is not limited thereto, and a neural network suitable for receiving input information according to the spirit of the present invention and outputting a result of recognizing an object expressed in the input information is sufficient.

The preprocessing module 110 may also be used in the process of training the neural network.

The preprocessing module 110 may generate input information according to the spirit of the present invention from an original image. As described below, the input information may include a plurality of images in which features of an object (e.g., a character) to be recognized are enhanced.

The neural network may be trained through a plurality of learning data including a plurality of input information generated by the preprocessing module 110 and result values (e.g., recognition results) labeled in advance for the input information.

The neural network module 120 constructed through the learning may output a result of recognizing an object expressed in the input information when input information of a format used in the learning is inputted.

According to the spirit of the present invention, the preprocessing module 110 may generate a plurality of images from an original image. Each of the created images may be an image in which features of an object are enhanced in a predetermined way.

The enhanced images may be inputted into the neural network through different channels, and may be learned to output one output value, i.e., a recognition result. When the neural network module 120 trained in this manner is used, each of the plurality of enhanced images may be inputted into the neural network module 120 when actual recognition is performed.

However, according to another embodiment of the present invention, the plurality of images generated by the preprocessing module 110 may be combined or stitched into one image. In this specification, an image generated by combining or stitching a plurality of images into one image is defined as an input image.

The input image may be an image in which a plurality of images is simply connected and stitched together so that each of the plurality of images may be displayed as it is.

When images having features of an object (e.g., a character) enhanced in a predetermined way are displayed respectively and an input image generated by stitching the images is used as described above, there is an effect of obtaining further higher recognition performance compared with simply inputting the enhanced images into a neural network through different channels.

It is since that, as described below, each of the enhanced images generated by the preprocessing module 110 is formed from the same image in a predetermined manner to enhance the features of an object (e.g., a character), and when images having features enhanced in different ways are displayed in one image (input image) at the same time, the difference in the way itself of enhancing the features may act as another feature of the input image.

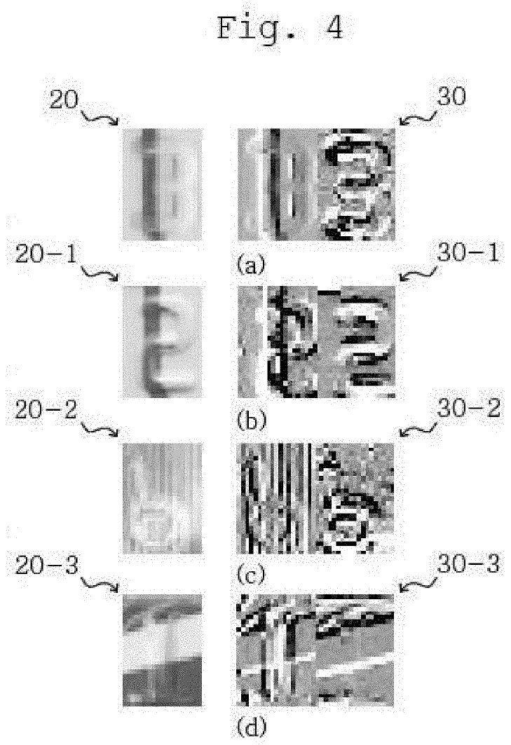

For example, in the example shown in FIG. 4, the left side may show an original image that has undergone a predetermined preprocessing process, and the right side may show an example of an input image generated by connecting images enhanced respectively in a plurality of (e.g., two) ways to each other.

Actually, as a result of the experiment conducted by the inventors of the present invention, it may be confirmed that learning by inputting an input image generated by connecting a plurality of enhanced images into a neural network as shown on the right side of FIG. 4 may further enhance the recognition performance, compared with learning by inputting each of the plurality of enhanced images into the neural network through separated channels.

On the other hand, as described above, according to the spirit of the present invention, the recognition system 100 does not recognize an original image to be recognized as is through a neural network, but may generate a plurality of images, in which features of an object (e.g., a character) displayed in the original image are enhanced in different ways, from the original image and allow the neural network to recognize the plurality of generated images.

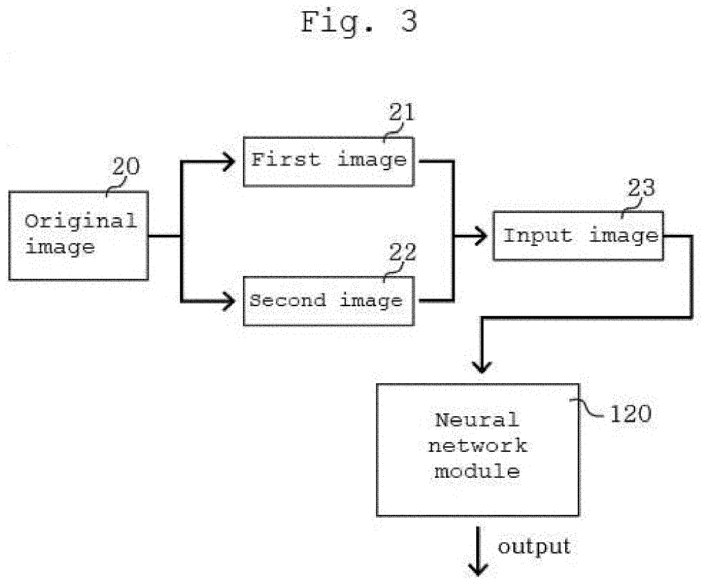

This concept will be described with reference to FIG. 3.

FIG. 3 is a view showing the process of an object recognition method according to an embodiment of the present invention. In addition, FIG. 4 is a view showing an example of an original image and an input image used in an object recognition method according to an embodiment of the present invention.

First, referring to FIG. 3, the preprocessing module 110 may generate a plurality of enhanced images from the original image 20 to implement a method of recognizing an object (e.g., a character) according to the spirit of the present invention. Hereinafter, although a case of using two enhanced images (e.g., a first image 21 and a second image 22) is described as an example in this specification, average experts in the technical field of the present invention may easily infer that more enhanced images may be used according to embodiments.

The original image 20 processed by the preprocessing module 110 may not be a raw image photographed by an image capturing apparatus, but may be an image on which predetermined preprocessing has already been performed through a predetermined preprocessing process. For example, the image may be an image preliminarily preprocessed using edge detection, histogram of oriented gradient (HOG), or various other image filters. In addition, the preliminary preprocessing may include a process of detecting a position of an object (e.g., a character) to be recognized or performing a crop in advance by the unit of object (e.g., character). Of course, according to embodiments, the preprocessing module 110 may perform preliminary preprocessing from a raw image, which is an original image 20, or the preprocessing module 110 may receive an original image 20 that has been preliminarily preprocessed. Examples of the original image 20 may be as shown on the left side of FIG. 4.

FIG. 4 exemplarily shows a case in which an object (e.g., a character) is a numeral, and original images 20 to 20-3 respectively derived from an image of an object (e.g., a character) displayed on a financial card (e.g., a credit card, a check card, etc.) through preliminary preprocessing are displayed as an example.

Then, the preprocessing module 110 may generate a first image 21 having features enhanced in a first method and a second image 22 having features enhanced in a second method from an original image (e.g., 20 to 20-3) in which the same object is displayed.

According to the spirit of the present invention, the preprocessing module 110 may use a differential image to enhance the features. The differential image may be an image using a difference value between a specific pixel value pₘ of an original image and a predetermined adjacent pixel pₙ of the specific pixel pm as a pixel value of a pixel included in the differential image.

A plurality of differential images may be generated from the same original image depending on the direction of an adjacent pixel pₙ, a difference value of which is used. In addition, when the same pixel values continuously exist or in a region that is not a major feature of an object to be recognized, this differential image may have an effect of enhancing the features of converting the pixel values to 0 or a relatively small value and allowing the major features to have a relatively large value.

Accordingly, the preprocessing module 110 may generate a first image 21, which is a differential image of a first direction, from the original image 20, and a second image 22, which is a differential image of a second direction, from the original image 20, respectively.

According to an example, the preprocessing module 110 may generate the first image 21, which is a differential image of the x-axis direction, from the original image 20, and the second image 22, which is a differential image of the y-axis direction, from the original image 20, respectively.

The features of the generated images, i.e., the first image 21 and the second image 22, may be inputted into the neural network so that the neural network may learn.

That is, it is not that one piece of input information to be inputted into the neural network module 120 is generated through predetermined data processing on the basis of the generated images, but features of the images may be inputted into the neural network module 120 in a state preserved as they are. This method may be a method in which the images are inputted into the network module 120 through different channels respectively as described above, or a method of generating an image, i.e., an input image 23, by simply stitching the images not to be deformed, and inputting the input image 23 into the neural network module 120 as described above.

Then, the neural network module 120 may receive the input image 23 generated by the preprocessing module 110 as an input. Then, the neural network module 120 may output a result of recognizing an object displayed in the received input image 23.

Of course, when the neural network module 120 is trained, the neural network module 120 may be trained to receive an input image, on which a plurality of images is shown, and output only one object (e.g., a character).

Examples of the original image and the input image according to the spirit of the present invention may be as shown in FIG. 4. Although FIG. 4 exemplarily shows original images and input images derived from an image of a financial card as described above, the scope of the present invention is not limited thereto.

The left side of FIG. 4(a) shows an original image 20 displaying numeral ‘3’ from a captured image through predetermined preliminary preprocessing, and the right side of FIG. 4(a) shows an input image 30 generated by simply stitching an x-axis direction differential image (left side of 30) and a y-axis direction differential image (right side of 30) left and right. In this case, it can be easily understood that the features enhanced according to the respective differential images are different from each other. For example, on the left side of the object (e.g., numeral ‘3’) to be recognized in the original image 20, noise such as the background or the like exists in the y-axis direction, and it is understood that although some of the noise remains in the x-axis direction differential image, most of the noise is removed from the y-axis direction differential image, so that the features of the object is particularly well enhanced. In addition, when all these features enhanced differently are used for learning and actual object recognition of the neural network module 120 while the features are included in the input image 30 as they are, higher recognition performance may be exhibited.

In a similar manner, the left side of FIG. 4(b) shows an original image 20-1 displaying numeral ‘2’ from a captured image through predetermined preliminary preprocessing, and the right side of FIG. 4(b) shows an input image 30-1 generated by simply stitching an x-axis direction differential image (left side of 30-1) and a y-axis direction differential image (right side of 30-1) left and right from the original image 20-1.

In addition, the left side of FIG. 4(c) shows an original image 20-2 displaying numeral ‘6’ from a captured image through predetermined preliminary preprocessing, and the right side of FIG. 4(c) shows an input image 30-2 generated by simply stitching an x-axis direction differential image (left side of 30-2) and a y-axis direction differential image (right side of 30-2) left and right from the original image 20-2.

The left side of FIG. 4(d) shows an original image 20-3 displaying numeral ‘1’ from a captured image through predetermined preliminary preprocessing, and the right side of FIG. 4(b) shows an input image 30-3 generated by simply stitching an x-axis direction differential image (left side of 30-3) and a y-axis direction differential image (right side of 30-3) left and right from the original image 20-3.

As a result, according to the spirit of the present invention, as a plurality of images, in which the features of an object (e.g., a character) to be recognized are enhanced from an original image in different ways, is used for learning of a neural network for recognition, there is an effect of improving recognition performance. In addition, when an input image generated by stitching a plurality of images is used, there is an effect of training the neural network to have higher recognition performance.

In addition, although a case in which an object to be recognized is a character is described as an example in this specification, average experts in the technical field of the present invention may easily infer that the spirit of the present invention may be applied to recognition of various objects by training the neural network.

The object recognition method according to an embodiment of the present invention can be implemented as a computer-readable code in a computer-readable recording medium. The computer-readable recording medium includes all kinds of recording devices for storing data that can be read by a computer system. Examples of the computer-readable recording medium are ROM, RAM, CD-ROM, a magnetic tape, a hard disk, a floppy disk, an optical data storage device and the like. In addition, the computer-readable recording medium may be distributed in computer systems connected through a network, and a code that can be read by a computer in a distributed manner can be stored and executed therein. In addition, functional programs, codes and code segments for implementing the present invention can be easily inferred by programmers in the art.

While the present invention has been described with reference to the embodiments shown in the drawings, this is illustrative purposes only, and it will be understood by those having ordinary knowledge in the art that various modifications and other equivalent embodiments can be made. Accordingly, the true technical protection range of the present invention should be defined by the technical spirit of the attached claims.

1. An object recognition system comprising:
a preprocessing module for generating a first image, in which features of an object displayed in an original image to be recognized are enhanced in a first method on the basis of the original image, and a second image generated on the basis of the original image, in which the features of the object are enhanced in a second method; and
a neural network module trained to receive the first image and the second image generated by the preprocessing module and output a result of recognizing the object.

2. The system according to claim 1, wherein the first image is an image having a difference value between a predetermined pixel based on the original image and an adjacent pixel in a first direction of the pixel as a pixel value, and the second image is an image having a difference value between a predetermined pixel based on the original image and an adjacent pixel in a second direction of the pixel as a pixel value.

3. The system according to claim 2, wherein the first direction is an x-axis direction, and the second direction is a y-axis direction.

4. The system according to claim 1, wherein the preprocessing module generates an input image by stitching the first image and the second image in a predetermined direction, and the neural network module receives the input image.

5. An object recognition system comprising:
a preprocessing module for generating a first image generated from an original image to be recognized and having a difference value of an adjacent pixel in an x-axis direction as a pixel value, and a second image generated from the original image and having a difference value of an adjacent pixel in a y-axis direction as a pixel value, and generating an input image by stitching the generated first image and second image; and
a neural network module trained to receive the input image generated by the preprocessing module and output a result of recognizing the object displayed in the original image.

6. An object recognition method comprising the steps of:
generating a first image, in which features of an object displayed in an original image to be recognized are enhanced in a first method on the basis of the original image, and a second image generated on the basis of the original image, in which the features of the object are enhanced in a second method, by an recognition system; and
receiving the generated first image and second image and outputting a result of recognizing the object, by a neural network included in the recognition system.

7. The method according to claim 6, wherein the first image is an image having a difference value between a predetermined pixel based on the original image and an adjacent pixel in a first direction of the pixel as a pixel value, and the second image is an image having a difference value between a predetermined pixel based on the original image and an adjacent pixel in a second direction of the pixel as a pixel value.

8. The method according to claim 6, further comprising the step of generating an input image by stitching the first image and the second image in a predetermined direction,
wherein the step of receiving the generated first image and second image and outputting a result of recognizing the object by a neural network included in the recognition system receives the input image.

9. An object recognition method comprising the steps of:
generating a first image, in which features of an object displayed in an original image to be recognized are enhanced in a first method on the basis of the original image, by an recognition system; and
generating a second image generated on the basis of the original image, in which the features of the object are enhanced in a second method, by the recognition system, wherein
a result of recognizing the object is outputted through a predetermined neural network on the basis of the generated first image and second image.

10. An object recognition method comprising the steps of:
generating a first image generated from an original image to be recognized and having a difference value of an adjacent pixel in an x-axis direction as a pixel value, and a second image generated from the original image and having a difference value of an adjacent pixel in a y-axis direction as a pixel value, by an recognition system;
generating an input image by stitching the generated first image and second image, by the recognition system; and
receiving the generated input image and outputting a result of recognizing the object displayed in the original image, by a neural network included in the recognition system.

11. A computer-readable recording medium installed in a data processing device to perform the method recited in claim 6.

12. A computer-readable recording medium installed in a data processing device to perform the method recited in claim 7.

13. A computer-readable recording medium installed in a data processing device to perform the method recited in claim 8.

14. A computer-readable recording medium installed in a data processing device to perform the method recited in claim 9.

15. A computer-readable recording medium installed in a data processing device to perform the method recited in claim 10.
